(19) United States
(12) Patent Application Publication
(10) Pub. No.: US 2008/0270676 A1
(43) Pub. Date: Oct. 30, 2008

(54) Data Processing System and Method for Memory Defragmentation

(75) Inventor: Marco Jan Bekooij, 's Hertogenbosch (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/815,210

(22) PCT Filed: Jan. 26, 2006
(86) PCT No.: PCT/IB2006/050279

§ 371 Date: Feb. 29, 2008

(30) Foreign Application Priority Data
Jan. 31, 2005 (EP) 05100602.1

(51) Int. Cl. G06F 12/02

(52) U.S. Cl. 711/100; 711/E12.002

(57) ABSTRACT

A data processing system is provided in a stream-based communication environment. The data processing system comprises at least one processing unit (PU1, PU2) for a stream-based processing of a plurality of processing jobs (J1-J5), a memory means (MEM) having an address range; and a plurality of FIFOs memory mapped to part of the address range of the memory means (MEM), respectively. Each of the FIFOs is associated to one of said plurality of processing jobs (j1-j5) to enable their communication. An address translation unit (ATU) is provided for identifying address ranges in the memory means (MEM) which are not currently used by the plurality of FIFOs and for moving the address range of at least one FIFO to a currently unused address range in the memory means (MEM).

The present invention relates to a data processing system comprising at least one processing unit and a memory as well as a method for memory defragmentation within a data processing system.

In modern embedded systems especially for streaming processing the management of the available (on-chip) memory is crucial for its overall performance. Typically, a memory manager is provided for managing the memory. This is performed basically by a procedure to allocate and to deallocate part of the memory. The memory may be divided into several blocks. The allocation is performed by a request for an address space for a continuous number of n bytes and a pointer indicating the address of such an address space is returned. The deallocation is performed by releasing the indicated address space or blocks if it is not required anymore. Furthermore, the memory manager keeps track of any block of unallocated or freed blocks between allocated blocks. However, with a continuous allocation and deallocation the memory may become fragmented, such that new data can not be written into the memory as not sufficient continuous address is available.

There are several techniques available to perform a defragmentation of the memory, namely compactation and garbage collection. The compactation technique is based on moving all allocated blocks to one end of the memory such that all free address spaces are combined. Moving the allocated blocks will involve a copying of all the data in the allocated blocks. First of all a new location for each block is calculated to determine the distance a block is to be moved or copied. Then each pointer is updated by adding the amount that the block it is pointing to will be moved. Thereafter, the data is moved or copied. A garbage collection can be considered as an automatic memory management strategy to identify and to remove any unreachable memory space and to reclaim this memory space. The garbage collection identifies blocks that are inaccessible and can be performed by reference counting, by mark-and-sweep and by generational algorithms. Reference counting keeps in each block a count of the number of pointers to the block. When the count drops to zero the block can be freed. The mark-and-sweep technique involves a marking of all non-garbage blocks and a sweeping through all blocks and returns the unmarked blocks to a list of free blocks. The sweeping usually also includes the above described compaction. The generational collection involves dividing the memory into different spaces. All blocks are copied to a new space such that the old space is freed and can be added to the list of free blocks.

U.S. Pat. No. 6,286,016 relates to a data processing system with a real-time garbage collection by dynamically expanding and contracting the heap. The memory is divided into at least two parts. Reachable memory blocks or lines in one memory part are copied to the second part such that only unreachable blocks or lines are left in the first memory part. As data must be copied between the memory part this technique will require additional bandwidth and additional clock cycles.

U.S. Pat. No. 5,218,698 relates to a memory management process for garbage collection by discarding obsolete objects from the memory. All accessible objects are identified and are copied to an additional copy space. Accordingly, an additional copying of data is required.

In ‘A memory-efficient real-time non-copying garbage collector’, by Lim et al., in SIGPLAN Notices, vol. 34, no. 3, pp. 118-129, March 1999, a garbage collector is described. A page wise collection is used to locate pages of free memory which are dynamically re-assigned between free lists if required. A virtual memory is used to dynamically remap free pages into a continuous range. Here, the fragmentation is reduced to a single page. If the number of pages is small then the lists will be small and the fragmentation will be large. For a smaller fragmentation the lists will grow and can cost a significant amount of memory space. If for example 16 Mbyte of memory is divided in blocks of 100 Kb, memory space for a list of 640 entries is required while block of 100 bytes would require 640000 entries.

The above problems also occur in data processing systems with several processing units, i.e. a multiprocessor system, which communicate between each other via a FIFO. A FIFO is one continuous memory block in which multiple logical FIFOs can be allocated. One of the processing units acts as producer and produces or writes data into the FIFO while a further processing unit acts as consumer and reads or consumes data from the FIFO. However, if the FIFO is full or empty, the producing or consuming of data is stalled or interrupted.

Especially if several different jobs are being processed by a processing unit or by several processing units accessing a single FIFO memory, the FIFO memory can be fragmented if some of the jobs are started and stopped at run time. Each of the different processing jobs will require a part of the FIFO memory. At one point in time, one of the jobs may stop and the memory locations associated or reserved for this job will no longer be in use by this job and will be available again. However, as a subsequent job may also have been started before the above job has stopped, the subsequent job will be assigned to the memory address range after the above second job. If this second job however is stopped, the memory will be fragmented as an address range in between two jobs will not be occupied by data from a any job. Accordingly, a situation can occur where a further job requests a write access to the FIFO memory but is rejected even though sufficient space is available in the FIFO memory but this space is not associated by a common address range but it is fragmented over the FIFO memory.

It is therefore an object of the invention to provide a data processing system as well as a method for memory defragmentation which allow an efficient usage of the available memory by defragmenting the available memory without a significant performance degradation.

This object is solved by a data processing system according to claim 1, by a method for memory defragmentation according to claim 4 as well as an electronic device according to claim 5.

Therefore, a data processing system is provided in a stream-based communication environment. The data processing system comprises at least one processing unit for a stream-based processing of a plurality of processing jobs, a memory means having an address range, and a plurality of FIFOs memory mapped to part of the address range of the memory means, respectively. Each of the FIFOs is associated to one of said plurality of processing jobs to enable their communication. An address translation unit is provided for identifying address ranges in the memory means which are not currently used by the plurality of FIFOs and for moving the address range of at least one FIFO to a currently unused address range in the memory means.

Accordingly, a complex garbage collection scheme can be avoided and there is no need for an actual copying of data reducing the overhead of copying data. Furthermore, the temporal behavior of different jobs is not affected during the memory defragmentation. An approach is described which does not require a free list even if fragmentation is not allowed.

According to an aspect of the invention the address translation unit is adapted to move the address range of a FIFO to the next highest or lowest currently unused address range in the memory means.

According to a further aspect of the invention a read pointer and a write pointer are each associated to the FIFO. The pointers are each adapted by the address translation unit to the moved address range as soon as the read pointer and the write pointer reach the end of the FIFO. As merely the write and read pointers are updated the defragmentation can be performed at run-time.

The invention also relates to a method of defragmentation of a memory in a data processing system in a stream-based communication environment having at least one processing unit for a stream-based processing of a plurality of processing jobs, a memory means having an address range; and a plurality of FIFOs memory mapped to part of the address range of the memory means, respectively. Each of the FIFOs is associated to one of said plurality of processing jobs to enable their communication. Address ranges in the memory means which are not currently used by the plurality of FIFOs are identified. The address range of at least one FIFO is moved to a currently unused address range in the memory means.

The invention also relates to an electronic device in a stream-based communication environment. The electronic device comprises at least one processing unit for a stream-based processing of a plurality of processing jobs, a memory means having an address range, and a plurality of FIFOs memory mapped to part of the address range of the memory means, respectively. Each of the FIFOs is associated to one of said plurality of processing jobs to enable their communication. An address translation unit is provided for identifying address ranges in the memory means which are not currently used by the plurality of FIFOs and for moving the address range of at least one FIFO to a currently unused address range in the memory means.

The invention is based on the idea to improve a memory defragmentation in a FIFO-based media streaming processing environment. The location of one logical FIFO is moved at a time to the highest/lowest empty position in the memory during the execution of a job. After a certain time period all logical FIFOs are placed consecutively in the memory. This can be achieved by adapting the read/write pointer of a FIFO (to a higher/lower empty position) as soon as the end of the FIFO has been reached and a higher/lower empty position is present.

These and other aspects of the invention are apparent from and will be elucidated with reference to the embodiments described hereinafter.

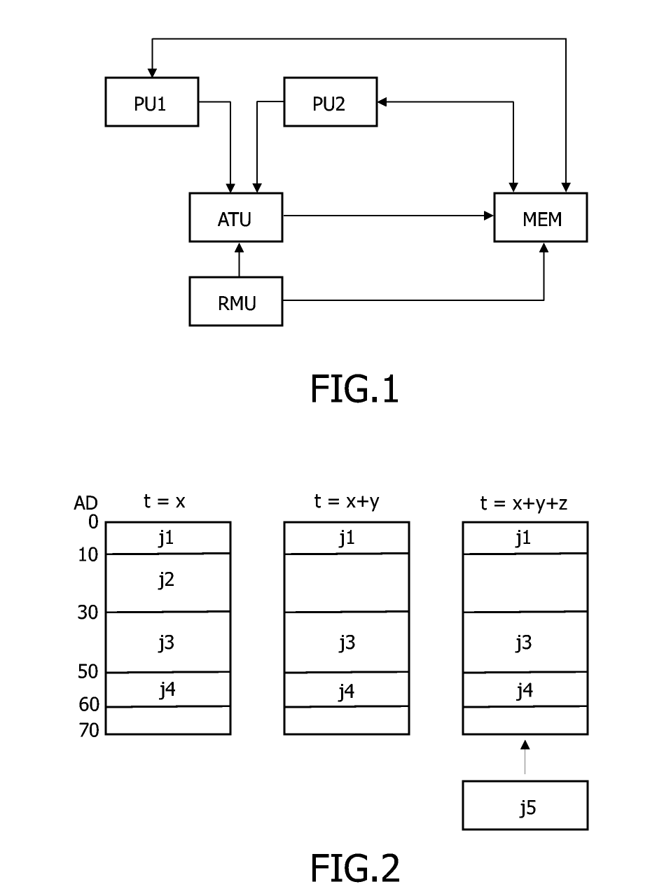

FIG. 1 shows a block diagram of a basic architecture of a system on chip according to the invention; and

FIG. 2 shows a basic representation of the fragmentation of a memory.

The architecture of the preferred embodiments of the invention is in particularly designed for processing continuous media streams within a multi-processing environment, i.e. it is designed for media processing applications with an ability of a run-time reconfiguration without a significant performance degradation. The signal processing of such media application includes a stream-based processing with FIFO periodic communication behavior. An efficient logical FIFO implementations require that the address range for one FIFO should be continuous such that the next word in the FIFO can be found by an increment of the pointer in the FIFO.

FIG. 1 shows a block diagram of an architecture of a system on chip according to a preferred embodiment of the invention. The system comprises a first and second processing unit PU1, PU2, a memory means MEM and an address translation unit ATU. The first and second processing unit PU1, PU2 are each connected to the memory and the address translation unit ATU. The memory means MEM and the address translation unit ATU are also connected. Although here two processing units are shown, the architecture of FIG. 1 may also be implemented by a plurality of processing units. The connection between the processing units PU1, PU2 and the memory MEM may relate to a data connection or a data bus, while the connection between the processing units PU1, PU2 to the memory means via the address translation unit ATU relate to an address connection or an address bus. The address translation unit ATU serves to translate the address ranges of the processing units PU1, PU2 to the address ranges of the memory means MEM, i.e. the logical addresses are translated to the actual physical addresses. The communication of the processing units PU1, PU2 is preferably FIFO based, wherein the FIFOs are mapped to the memory means MEM, i.e. the FIFOs are memory mapped to the memory means MEM.

Optionally, a switching means SM (not shown) may be coupled between the processing units PU1, PU2 and the memory means MEM in order to select one of the processing units PU1, PU2 and connect the selected processing unit PU1, PU2 to the memory means MEM. Additionally or alternatively, a resource managing unit RMU (not shown) may also be provided which may be connected to the address translation unit ATU and the memory means MEM. The resource managing unit RMU serves to manage the resources of the overall data processing system.

FIG. 2 shows a basic representation of fragmentation of a memory means of FIG. 1. Here, the situation in the memory means MEM is shown at three different time instants, namely t=x, t=x+y, and t=x+y+z. The memory means MEM comprises an address range AD from 0 to 70. Each job j1-j5 corresponds to a processing from one of the streams being processed by the data processing system and is implemented as a FIFO. Each job will use and occupy part of the memory space of the memory means MEM. At t=x the data of 4 jobs is stored in the memory means MEM. The first job j1 requires 10 addresses or 10 memory locations, namely from 0-10. The second job j2 requires 20 memory locations (from 10-30), the third job j2 requires 20 memory locations (from 30-50), and the fourth job j4 requires 10 memory locations (from 50-60). At t=x+y the processing of the second job j2 is stopped and the memory locations 10-29 are not required anymore and can be freed. At t-x+y+z a fifth job j5 requiring 30 consecutive memory locations is started. However, as no 30 consecutive or continuous memory locations are present in the memory means MEM, the fifth job j5 must be rejected.

In order to avoid the problem of fragmented memory space one logical FIFO, i.e. associated to one job, is moved to the highest or lowest position unoccupied position the memory means MEM while the job is executed, i.e. at run-time. This can be achieved without actually copying the data. The location of the FIFO of a job is moved upwardly by continuing the reading and writing at a new more upward location after the end of a FIFO is reached at the original position. This scheme may be described with reference to the situation according to FIG. 2. After the data from the third job has reached the address 49 (at t=x+y) the subsequent data from this job is continuously written to the memory address range 10-29. The same applies to the case that data is read from the memory space or FIFO associated to the third job j3. In other words as soon as the last data item in a FIFO has been accessed and the processing is to be continued by accessing the first data item in the FIFO, the location of the FIFO is changed to the next upward (downward) free memory space such that the next data item is written to a different more upward (downward) address in the memory means. The address range of the FIFO is moved upward after the last data item in FIFO. As soon as the write and read pointer has been moved to the address range 10-29, the memory range 30-49 previously occupied by the third job j3 can be freed and re-used by the fourth job j4 by updating the pointers to the address range starting at 30. As soon as the FIFO of the fourth job j4 is moved, the FIFO from the fifth job j5 can be accommodated in the memory means MEM.

The address translation unit ATU is designed to monitor the address bus of the system. It can detect the end of each FIFO. Once the end of a FIFO has been reached a write/read to this end of the FIFO has occurred the pointer (or the addresses) to the successive write/read will be adapted to the next upward free address. Accordingly, the address translation unit ATU also has to identify any unused memory space to determine if the address range of a FIFO can be moved upward such that a memory fragmentation is successfully prevented. According to this embodiment the address translation unit ATU is implemented in hardware. However, a software implementation is also possible.

A pseudo code of such an implementation is now described:

if(wp_base==base+range)

wp_base=p_base;

wp=wp_base+wp_curr;
wp_curr=(wp_curr+1)%range;
if(rp==base+range)

rp_base=p_base;

signal_finish_move ( );
rp=rp_base + rp_curr;
rp_curr=(rp_curr+1)%range;

In a logical FIFO a read pointer rp and a write pointer wp is used. The value of the read pointer is only updated by the consumer and the value of the write pointer is only updated by the producer. Because there is only one task which updates these pointers there is no need to apply semaphores. The consumer and producer task can of course read both pointers. From the difference between the two pointers wp, rp and the capacity in number of words of the FIFO the amount of data in the FIFO as well as the amount of space in the FIFO can be derived. For example if the token size is one word then subtracting the write pointer from the read pointer tells how much data words are stored in the FIFO. The space in the FIFO is than capacity-(wp-rp). The wrap around effects of the pointers rp, wp are handled by reserving an additional MSB bit in the pointer. For more information refer to “A Scalable and Flexible Data Synchronization Scheme for Embedded HW-SW Shared-Memory Systems”, by Lippens et at in Proceedings of the 14th international symposium on Systems synthesis (ISSS '01) Sep. 30-Oct. 3, 2001, Montreal, Canada.

A FIFOs starts at a certain address which is denoted as the base in the above pseudo code. Accesses in the FIFO are relative to the base. The base wp_base for the pointer wp is changed after the write pointer exceeds the end of the FIFO at the current location wp_curr (base+range). This way new data is written at lower addresses in the memory and the FIFO moves up (towards address 0) in the memory. After the read pointer rp has exceeded (base+range) the FIFO has been moved. The time it takes to move the FIFO to the new position can be calculated given the minimum read data rate.

If the tokens are larger than one word then the number of tokens in a FIFO can also be calculated from the pointers wp and rp. The number of tokens in a FIFO will correspond to floor ((wp-rp)/tokensize). Reading data words in a token will for example change the pointer rp but does not change the outcome of this equation. Therefore, the producer will know that no tokens have been released and that no addition space has become available.

In order to keep the overall amount of on-chip memory as small as possible it is preferable to perform the buffering of the required data as efficiently as possible. This can be done by providing a buffer or FIFO for every stream to be processed, wherein this buffer must be able to handle the peak bandwidth demands of the stream. An alternative solution is to provide a single larger shared buffer instead of a plurality of smaller buffers. The access of the plurality of processing units to the buffer can be performed by switching between the processing units. However, in order to guarantee (hard) real time constraints (as for audio or video processing) for all data streams, each of the streams must be able to access the necessary amount of buffer space at any time. Therefore, the buffer space or the cache space can be allocated to separate streams.

As the different data streams operate independently of each other and the cache or buffer space is dynamically allocated or deallocated to the different streams, a reconfiguration of the different streams during run-time is very difficult as not a single instant will be present without any active stream.

Alternatively or additionally, the buffer or cache can be divided into a section for stream based periodic processing and into a further section for random accesses, e.g. a debugger.

The above described principles of the invention may also be implemented by an electronic device instead of a data processing system.

It should be noted that the above-mentioned embodiments illustrate rather than limit the invention, and that those skilled in the art will be able to design many alternative embodiments without departing from the scope of the appended claims. In the claims, any reference signs placed between parenthesis shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

Furthermore, any reference signs in the claims shall not be constitute as limiting the scope of the claims.

1. Data processing system in a stream-based communication environment comprising: at least one processing unit for a stream-based processing of a plurality of processing jobs;—a memory means having an address range; a plurality of FIFOs memory mapped to part of the address range of the memory means, respectively; wherein each of the FIFOs is associated to one of said plurality of processing jobs to enable their communication; an address translation unit for identifying address ranges in the memory means which are not currently used by the plurality of FIFOs and for moving the address range of at least one FIFO to a currently unused address range in the memory means.

2. Data processing system according to claim 1, wherein the address translation unit is adapted to move the address range of a FIFO to the next highest or lowest currently unused address range in the memory.

3. Data processing system according to claim 2, comprising a read pointer and a write pointer associated to the FIFO, which are each adapted by the address translation unit to the moved address range as soon as the read pointer and the write pointer reach the end of the FIFO.

4. Method of defragmentation of a memory in a data processing system in a stream-based communication environment having at least one processing unit for a stream-based processing of a plurality of processing jobs, a memory means having an address range; and a plurality of FIFOs memory mapped to part of the address range of the memory means, respectively, comprising the steps of: associating each of the FIFOs to one of said plurality of processing jobs to enable their communication; identifying address ranges in the memory means which are not currently used by the plurality of FIFOs, and moving the address range of at least one FIFO to a currently unused address range in the memory means.

5. Electronic device, in a stream-based communication environment, comprising: at least one processing unit for a stream-based processing of a plurality of processing jobs; a memory means having an address range; a plurality of FIFOs memory mapped to part of the address range of the memory means, respectively; wherein each of the FIFOs is associated to one of said plurality of processing jobs to enable their communication;—an address translation unit for identifying address ranges in the memory means which are not currently used by the plurality of FIFOs and for moving the address range of at least one FIFO to a currently unused address range in the memory means.
